(19) United States
(12) Patent Application Publication
(10) Pub. No.: US 2025/0247489 A1
(43) Pub. Date: Jul. 31, 2025

(54) IMAGE PROCESSING SYSTEM, NON-TRANSITORY COMPUTER READABLE MEDIUM STORING PROGRAM, AND IMAGE PROCESSING METHOD

(71) Applicant: FUJIFILM Business Innovation Corp., Tokyo (JP)

(72) Inventor: Teppei NAGATOMI, Kanagawa (JP)

(73) Assignee: FUJIFILM Business Innovation Corp., Tokyo (JP)

(21) Appl. No.: 18/780,502

(22) Filed: Jul. 23, 2024

(30) Foreign Application Priority Data
Jan. 29, 2024 (JP) 2024-011166

(51) Int. Cl. H04N 1/60; H04N 1/00

(52) U.S. Cl. CPC H04N 1/60; H04N 1/00023

(57) ABSTRACT

An image processing system includes a processor configured to: in a case where color correction on a raster image is designated in a print instruction and there is a possibility of an occurrence of a defect in a color-corrected image in a case where the color correction is performed on the raster image, issue a warning to a user about the defect that will occur in the color-corrected image.

### CROSS-REFERENCE TO RELATED APPLICATIONS

This application is based on and claims priority under 35 USC 119 from Japanese Patent Application No. 2024-011166 filed Jan. 29, 2024.

### BACKGROUND

### (i) Technical Field

The present disclosure relates to an image processing system, a non-transitory computer readable medium storing a program, and an image processing method.

### (ii) Related Art

JP2006-350798A discloses an image processing apparatus that changes a color of a text having a possibility of being garbled on a printing apparatus side to perform printing in response to an instruction from a user using a driver or a utility, so as to simplify an inspection of the text garbling.

JP2008-160476A discloses an image processing apparatus that discriminates an object of an input print job, performs color conversion processing in a rendering color space in a case where the discriminated object is a transparent object, and performs color conversion processing in a device color space in a case of a gradation.

### SUMMARY

In a case where color correction is performed on a raster image on which the rasterization processing has been performed, a defect may occur in the color-corrected image. For example, in a case where a display object to which a transparent effect is applied exists in an image to be printed, in a case where the color correction is performed on the raster image, a color banding occurs at a boundary between a region to which the transparent effect is applied and a region to which the transparent effect is not applied, and a defect occurs in the image. It is difficult for a user to understand which type of display object included in the image causes the defect in the color-corrected image in a case where the color correction is performed on the raster image.

Aspects of non-limiting embodiments of the present disclosure relate to an image processing system, a non-transitory computer readable medium storing a program, and an image processing method that can enable a user to understand that, in a case where there is a possibility of an occurrence of a defect in an image in a case where color correction is performed on a raster image, there is the possibility of the occurrence of the defect in the color-corrected image.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including: a processor configured to: in a case where color correction on a raster image is designated in a print instruction and there is a possibility of an occurrence of a defect in a color-corrected image in a case where the color correction is performed on the raster image, issue a warning to a user about the defect that will occur in the color-corrected image.

### BRIEF DESCRIPTION OF THE DRAWINGS

Exemplary embodiment(s) of the present invention will be described in detail based on the following figures, wherein:

FIG. 1 is a diagram showing a configuration of an image forming system according to an exemplary embodiment of the present disclosure;

FIG. 2 is a diagram showing an example of an original image on which a text image to which a visual effect called a drop shadow is applied is superimposed;

FIG. 3 is a diagram showing an example of a text image to which the visual effect called the drop shadow is applied;

FIG. 4 is a diagram showing simple display of the text image to which the visual effect called the drop shadow is applied;

FIG. 5 is a diagram showing an example of an image in a case where the text image to which the drop shadow is applied is added to the original image shown in FIG. 2;

FIG. 6 is a diagram showing an example of an image after the color correction is performed on the image shown in FIG. 5 at a stage of intermediate data;

FIG. 7 is a diagram showing an example of an image after the color correction is performed on the image shown in FIG. 5 at a stage of a raster image;

FIG. 8 is an enlarged view of a part of the image shown in FIG. 7;

FIG. 9 is a diagram showing a CMYK color correction application region and a non-application region in which the CMYK color correction is not applied;

FIG. 10 is a diagram showing an example of a gradation object of a spot color;

FIG. 11 is a diagram showing an example of an image in a case where the gradation object of the spot color shown in FIG. 10 is overprinted on the original image shown in FIG. 2;

FIG. 12 is a diagram showing an example of an image in a case where the CMYK color correction is performed on an image in which the gradation object of the spot color is overprinted;

FIG. 13 is a diagram showing a hardware configuration of a print server 10 in the image forming system according to the exemplary embodiment of the present disclosure;

FIG. 14 is a block diagram showing a functional configuration of the print server 10 in the image forming system according to the exemplary embodiment of the present disclosure;

FIG. 15 is a diagram showing a data flow between processing units in the print server 10;

FIG. 16 is a flowchart showing a flow of RIP processing in an RIP processing unit 33;

FIG. 17 is a flowchart showing a flow of drawing processing in a drawing processing unit 34;

FIG. 18 is a diagram showing an example of attribute information included in PDL data;

FIG. 19 is a diagram showing a display screen example in a case where a countermeasure to prevent an image defect from occurring is suggested on a display screen of raster image viewer software for displaying a raster image in a preview manner on a client terminal 20;

FIG. 20 is a diagram showing a display screen example in a case where a warning is issued to a user about a defect that will occur in a color-corrected image on the client terminal 20;

FIG. 21 is a diagram showing an example of a screen in a case where selection of whether or not to issue the warning about the defect that will occur in the color-corrected image is received from the user;

FIG. 22 is a diagram showing another example of the screen in a case where the selection of whether or not to issue the warning about the defect that will occur in the color-corrected image is received from the user;

FIG. 23 is a flowchart showing processing in a case where the warning is issued by extracting only a display object that is a warning target;

FIG. 24 is a diagram showing an output example in a case where extraction display of an image defect portion is performed;

FIG. 25 is a flowchart showing processing in a case where the warning is issued by re-coloring the display object that is the warning target with a warning color;

FIG. 26 is a diagram showing an output example in a case where a color of the display object of the image defect portion is re-colored with the warning color;

FIG. 27 is a flowchart showing processing in a case where the warning is issued by changing the color correction of the display object that is the warning target;

FIG. 28 is a diagram showing an output example in a case where color correction for a warning is performed on the display object of the image defect portion; and

FIG. 29 is a flowchart showing processing in a case where the warning is issued by changing the color correction of the display object that is the warning target in a raster image correction processing unit 52.

### DETAILED DESCRIPTION

Hereinafter, an exemplary embodiment of the present disclosure will be described in detail with reference to the drawings.

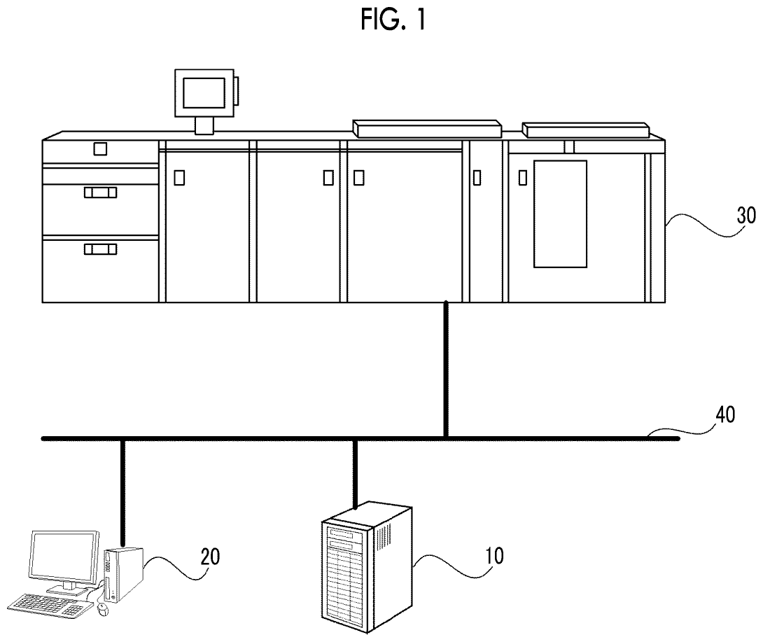

FIG. 1 is a diagram showing a configuration of an image forming system according to the exemplary embodiment of the present disclosure.

As shown in FIG. 1, an image forming system according to the exemplary embodiment of the present disclosure has a configuration in which a print server 10, a client terminal 20, and a printer 30 for business are connected to each other via a network 40. The print server 10 is an image processing apparatus or an image processing system that performs control of executing print processing on the printer 30 based on a print job, which is a print instruction received from the client terminal 20. Here, the print job described by a page description language (PDL) is transmitted from the client terminal 20 to the print server 10. Therefore, the print server 10 performs processing of converting the print job described by the PDL into a raster image and transferring the raster image to the printer 30.

Here, in the print server 10, the print job is not directly converted into the raster image, but the print job described by the PDL is once converted into intermediate data, and the intermediate data is converted into the raster image printable by the printer 30. The intermediate data is data having a format that is easier to convert into the raster image than PDL data.

In the image forming system as described above, instead of printing the print job as it is by the printer 30, there may be a case where a color value is changed by performing color correction or color conversion, and then the printing is performed. In the following description, both the color correction and the color conversion are described as the color correction.

In addition, the print server 10 can perform the color correction at a stage of the intermediate data, and can also perform the color correction at a stage of the raster image. The stage at which the color correction is performed is designated in a case where a print instruction is issued from the client terminal 20 to the print server 10.

Here, in a case where the color correction is performed on the raster image on which the rasterization processing has been performed, processing using hardware can be performed, and thus fast processing can be realized. However, in a case where the intermediate data is converted into the raster image, information such as an object type and color space information in attribute information on the PDL data is lost, and thus a defect may occur in the color-corrected image in a case where the color correction is performed on the raster image.

For example, in a case where an object to which a transparent effect is applied exists in an image to be printed, in a case where the color correction is performed on the raster image, a color banding occurs at a boundary between a region to which the transparent effect is applied and a region to which the transparent effect is not applied, and the defect occurs in the image.

Meanwhile, in a case where the color correction is performed on the intermediate data, it is possible to execute processing using accurate attribute information in the PDL data, so that it is possible to accurately reproduce the color. However, since it is necessary to execute color correction processing for each display object (or drawing object) in the PDL data, a processing time may be lengthened.

Therefore, in order to reduce the processing time, it is necessary to perform the color correction at the stage of the raster image as much as possible. However, it is difficult for a user to understand which type of display object included in the image causes the defect in the color-corrected image in a case where the color correction is performed on the raster image.

Therefore, in the print server 10 according to the present exemplary embodiment, by performing control as described below, the user may be enabled to understand that, in a case where there is a possibility of the occurrence of the defect in the image in a case where the color correction is performed on the raster image, there is the possibility of the occurrence of the defect in the color-corrected image.

First, before describing the image forming system according to the present exemplary embodiment, a specific example of a case where the image defect occurs in a case where the color correction is performed on the raster image will be described with reference to the drawings.

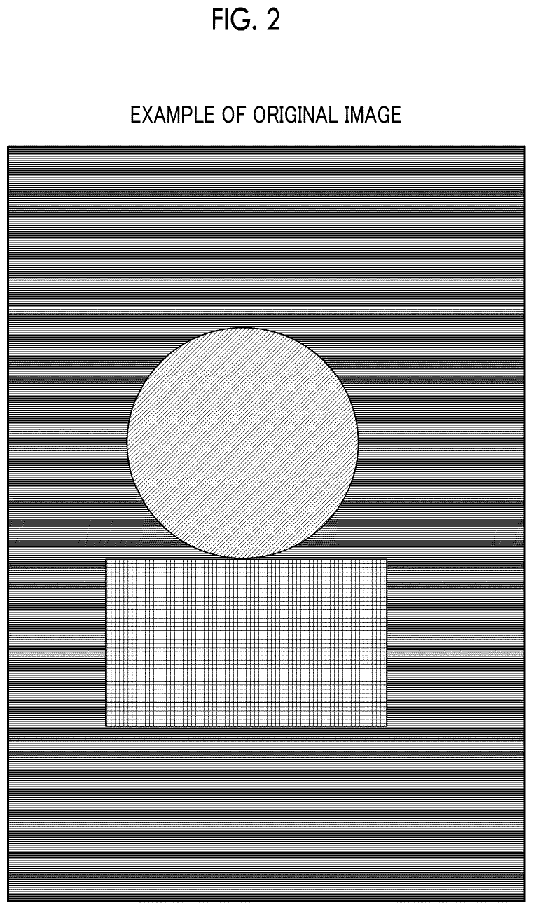

For example, a case where a text image to which a visual effect called a drop shadow is applied is superimposed on an original image as shown in FIG. 2 will be described. Although an actual image is a photographic image or a complex image in which various colors are used, in the present exemplary embodiment, for the sake of simplicity, a case where a simple image as shown in FIG. 2 is used as the original image will be described.

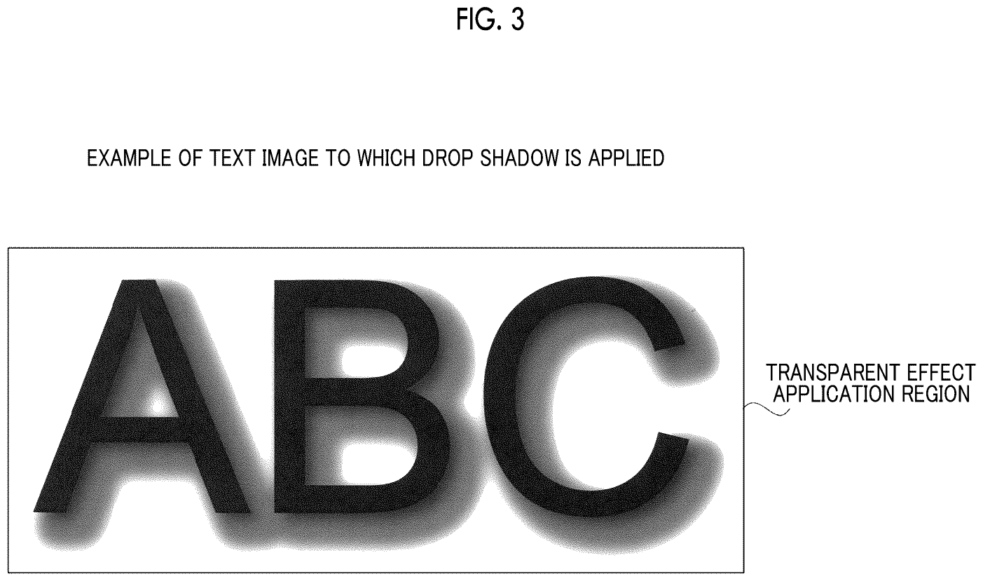

FIG. 3 shows an example of a text image to which such a drop shadow is applied. The drop shadow is one of the visual effects for a text or a figure, and means a function of performing a production in which a shadow is cast on a side of a contour of an application object. In a case where the drop shadow is applied to the text or the figure, a vague gradation such as a shadow appears around the text or the figure, and the text or the figure can be made to appear to stand out from the display object in the background.

In a case where the drop shadow is applied to the text or the figure, as shown in FIG. 3, a transparent effect application region is set around the text or the figure by generating the shadow of the text or the figure by the gradation.

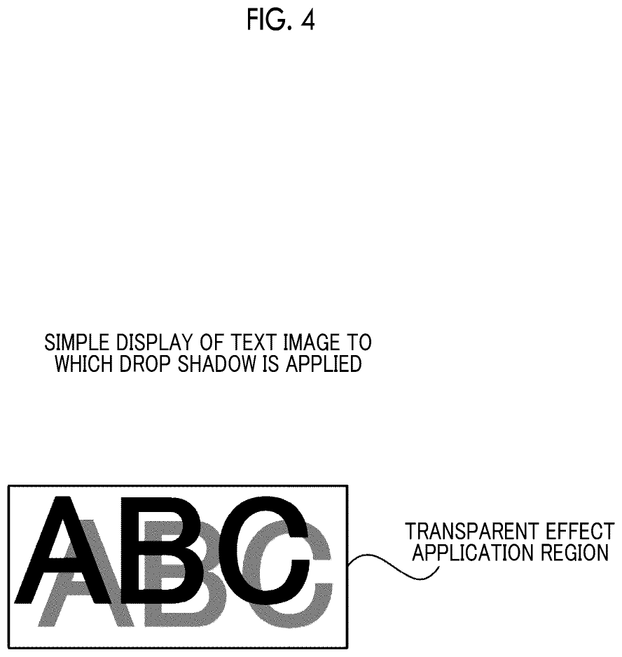

In practice, the text image to which the drop shadow is applied as shown in FIG. 3 is superimposed on the original image, but for ease of representation on the drawing, simple display shown in FIG. 4 will be used for the following description.

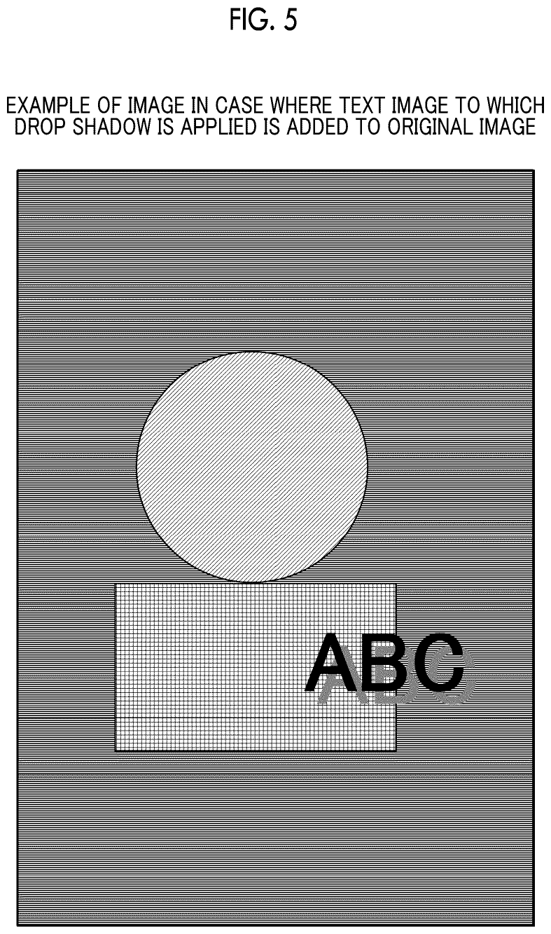

FIG. 5 shows an example of an image in a case where the text image to which the drop shadow is applied is added to the original image shown in FIG. 2. Referring to FIG. 5, it can be seen that a text string “ABC” to which the drop shadow is applied is added to a part of the original image shown in FIG. 2.

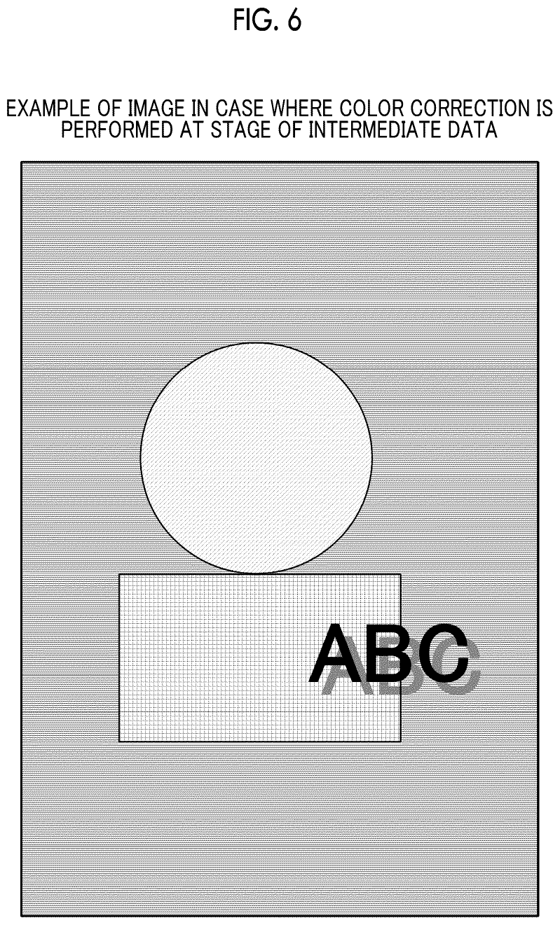

FIG. 6 shows an example of an image after the color correction is performed on the image shown in FIG. 5 at the stage of the intermediate data. It can be seen that, in a case where the color correction is performed at the stage of the intermediate data, the overall color value is changed without the occurrence of the image defect because the color correction is performed for each display object.

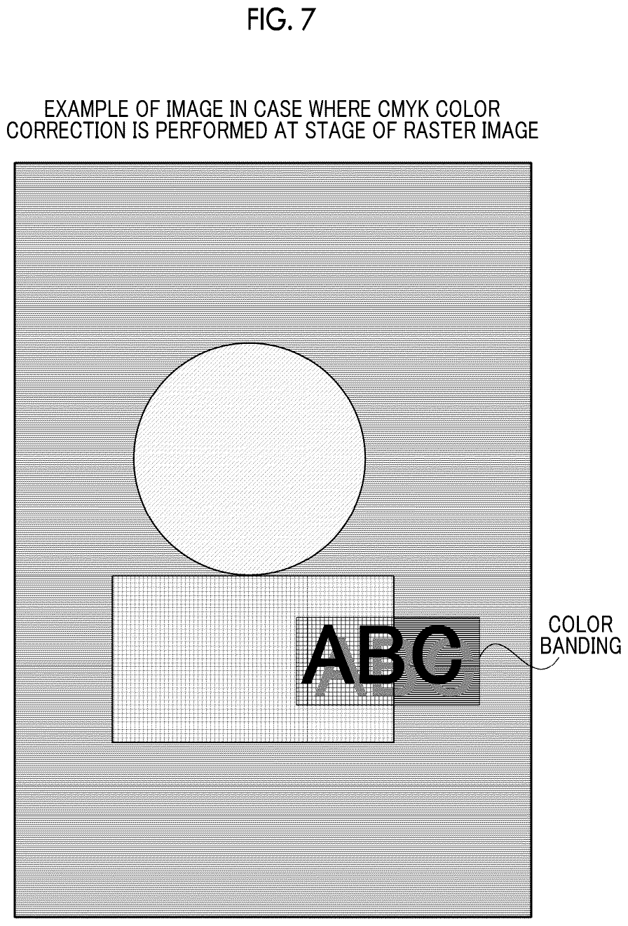

Meanwhile, FIG. 7 shows an example of an image after the color correction is performed on the image shown in FIG. 5 at the stage of the raster image. The raster image is data composed of a color value corresponding to a color of a coloring material such as a toner, such as CMYK. Therefore, the color correction at the stage of the raster image may be referred to as CMYK color correction.

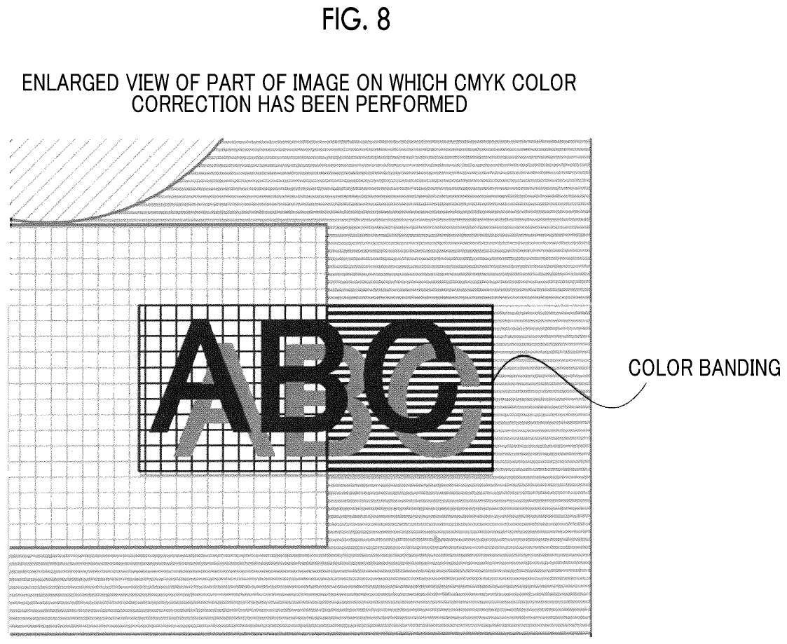

Referring to FIG. 7, it can be seen that, in a case where the CMYK color correction is performed at the stage of the raster image, a color banding occurs between a region of the text image to which the drop shadow is applied and the other region, and the color banding causes the image defect. FIG. 8 shows an enlarged view of a part of the image shown in FIG. 7. Referring to FIG. 8, it can be more clearly seen that the color banding in which the color value is rapidly changed occurs around the text string “ABC” to which the drop shadow is applied.

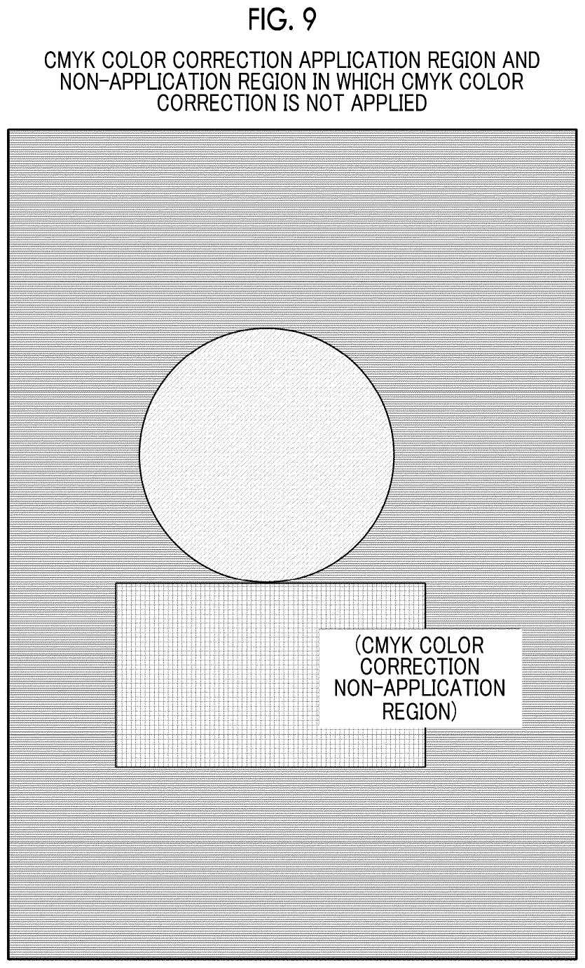

The reason why such a color banding occurs will be described with reference to FIG. 9. FIG. 9 is a diagram showing a CMYK color correction application region and a non-application region in which the CMYK color correction is not applied. A certain region including the text image to which the drop shadow is applied is a region to which the transparent effect is applied by setting the shadow having the gradation. The region to which the transparent effect is applied is set as an exclusion target of the CMYK color correction. Therefore, with reference to FIG. 9, it can be seen that a certain region including the text image to which the drop shadow is applied is a CMYK color correction non-application region.

Even in a case where the color correction is performed at the stage of the raster image, the color correction is not performed in the CMYK color correction non-application region. Therefore, at a boundary between the CMYK color correction application region and the CMYK color correction non-application region, the color value is rapidly changed, and thus the color banding occurs.

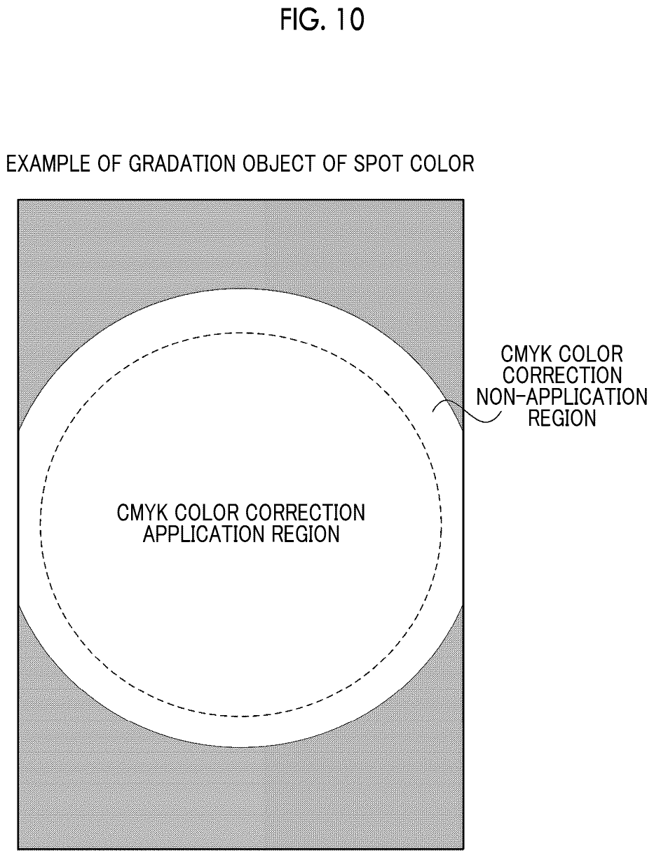

Further, another specific example of a case where the image defect occurs in a case where the color correction is performed on the raster image will be described with reference to FIGS. 10 to 12.

FIG. 10 is a diagram showing an example of a gradation object of a spot color. The gradation object of the spot color is the display object used in a case where a frame is provided in the photographic image. The gradation object of the spot color has a shape in which a circular hole is provided in the center of a rectangle, and has a shape in which a background image is visible. Therefore, by overprinting the gradation object of the spot color on the photographic image, it is possible to obtain an effect of adding a round frame to the photographic image. Here, there is nothing on a center side region in a circular region of the gradation object of the spot color, and the background image appears as it is even in a case of overprinting. However, in FIG. 10, a region outside a dotted circle indicated is a region in which a gradation image with the gentle gradient exists and the transparent effect is applied. As a result, in the gradation object of the spot color shown in FIG. 10, a region inside the dotted circle is the CMYK color correction application region, and the region outside the dotted circle is the CMYK color correction non-application region.

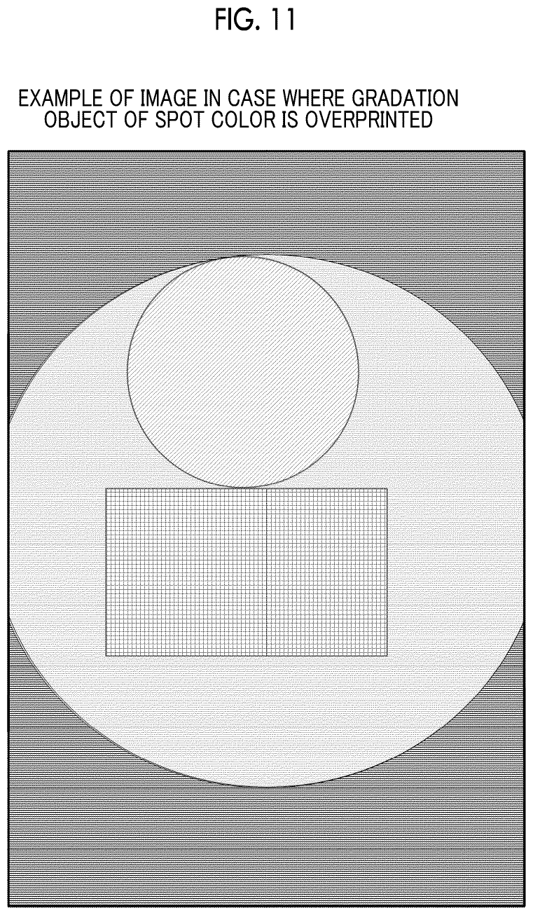

FIG. 11 shows an example of an image in a case where the gradation object of the spot color shown in FIG. 10 is overprinted on the original image shown in FIG. 2.

Referring to FIG. 11, it can be seen that only the image of the center region of the original image appears in a circular shape, and the other region is covered with the gradation object of the spot color. In a case where the color correction is performed on the image shown in FIG. 11 at the stage of the intermediate data, the same color correction is performed for all the regions that are visible, and the image defect such as color banding does not occur. However, in a case where the CMYK color correction is performed on the image shown in FIG. 11 at the stage of the raster image, the color banding appears as in the case described above, and the image defect occurs.

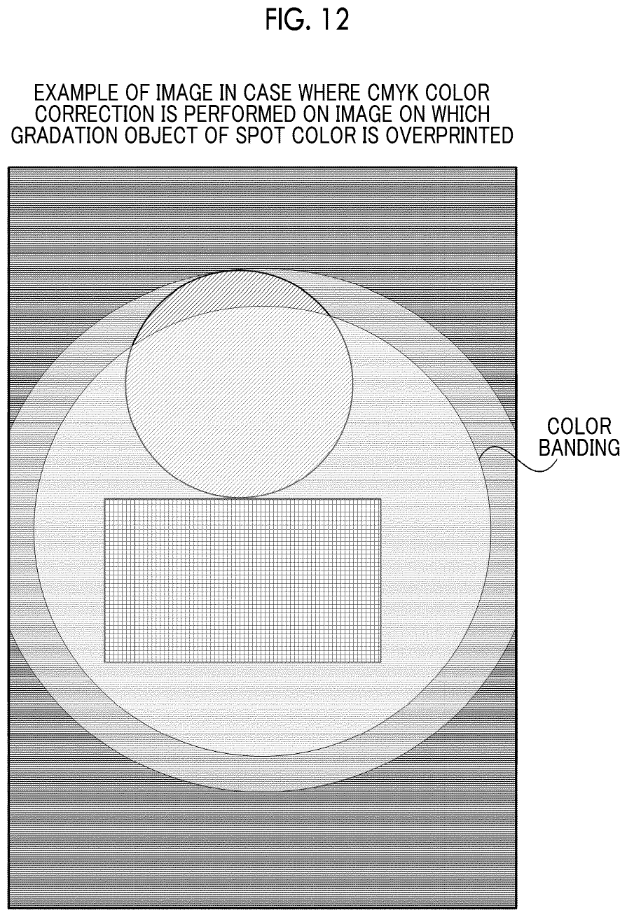

FIG. 12 shows an example of an image in a case where the CMYK color correction is performed on the image in which the gradation object of the spot color is overprinted. Referring to FIG. 12, it can be seen that the color banding occurs at a boundary between the CMYK color correction application region and the non-application region.

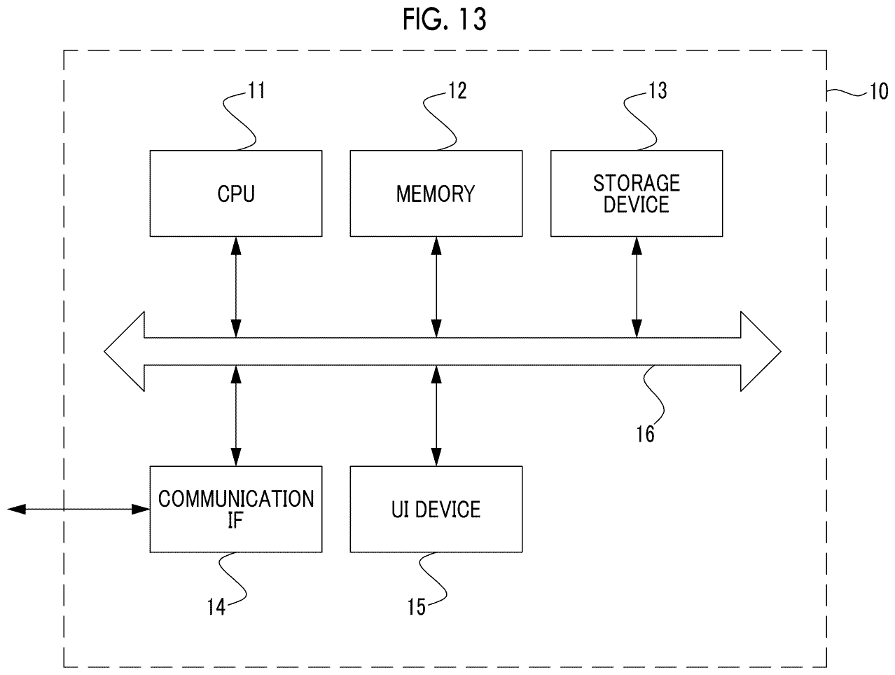

Next, FIG. 13 shows a hardware configuration of the print server 10 in the image forming system according to the present exemplary embodiment.

As shown in FIG. 13, the print server 10 includes a CPU 11, a memory 12, a storage device 13 such as a hard disk drive, a communication interface (referred to as an IF) 14 that transmits and receives data to and from an external device or the like via a network 40, and a user interface (referred to as a UI) device 15 including a touch panel or a liquid crystal display and a keyboard. These components are connected to each other via a control bus 16.

The CPU 11 is a processor that executes predetermined processing based on a control program stored in the memory 12 or the storage device 13, to control the operation of the print server 10. In the present exemplary embodiment, the description has been made in which the CPU 11 reads out and executes the control program stored in the memory 12 or the storage device 13, but the present disclosure is not limited to this. The control program may be provided in a form recorded on a computer-readable recording medium. For example, the program may be provided in a form recorded on an optical disk such as a compact disc (CD)-ROM and a digital versatile disc (DVD)-ROM, or in a form recorded on a semiconductor memory such as a universal serial bus (USB) memory and a memory card. Also, the control program may be acquired from the external device via a communication line connected to the communication interface 14. Further, the control program may be provided as single application software, for example, or may be incorporated into the software of each device as one function of the print server 10.

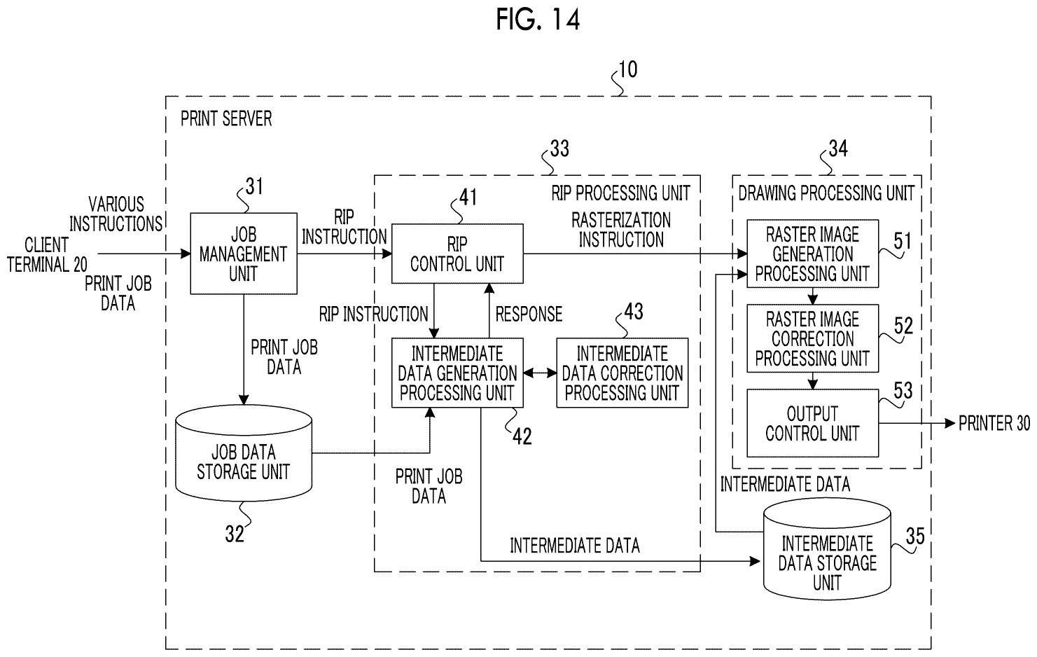

FIG. 14 is a block diagram showing a functional configuration of the print server 10 realized by executing the control program.

As shown in FIG. 14, the print server 10 according to the present exemplary embodiment includes a job management unit 31, a job data storage unit 32, a raster image processing (RIP) unit 33, a drawing processing unit 34, and an intermediate data storage unit 35.

The RIP processing unit 33 is composed of an RIP control unit 41, an intermediate data generation processing unit 42, and an intermediate data correction processing unit 43. The drawing processing unit 34 is composed of a raster image generation processing unit 51, a raster image correction processing unit 52, and an output control unit 53.

The job management unit 31 receives print job data described by a page description language (PDL) such as a portable document format (PDF) from the client terminal 20, and stores the print job data in the job data storage unit 32. The job management unit 31 receives various instructions for the print job received from the client terminal 20. In a case where a new print job is received, the job management unit 31 issues an RIP instruction for the print job to the RIP processing unit 33.

The RIP control unit 41 controls the operation of the RIP processing unit 33 and issues, in a case where the RIP instruction is received from the job management unit 31, the RIP instruction to the intermediate data generation processing unit 42 to convert the print job data into the intermediate data. In addition, the RIP control unit 41 issues a rasterization instruction to the drawing processing unit 34 to execute the rasterization processing on the intermediate data converted by the intermediate data generation processing unit 42 to convert the intermediate data into the raster image.

In a case where the RIP control unit 41 receives the RIP instruction, the intermediate data generation processing unit 42 responds to the RIP instruction and executes processing of acquiring the print job data from the job data storage unit 32 and converting the acquired print job data into the intermediate data based on the RIP instruction from the RIP control unit 41.

The intermediate data correction processing unit 43 performs the color correction, for which the instruction is issued, on the intermediate data generated by the intermediate data generation processing unit 42. The intermediate data on which the color correction has been performed by the intermediate data correction processing unit 43 is stored in the intermediate data storage unit 35 via the intermediate data generation processing unit 42.

The raster image generation processing unit 51 executes processing of acquiring the intermediate data from the intermediate data storage unit 35 and converting the acquired intermediate data into the raster image based on the rasterization instruction from the RIP control unit 41.

The raster image correction processing unit 52 performs the color correction, for which the instruction is issued, on the raster image generated by the raster image generation processing unit 51.

The output control unit 53 transfers the raster image data on which the color correction has been performed by the raster image correction processing unit 52 to the printer 30 as printable print data.

The image conversion unit is composed of the intermediate data generation processing unit 42 that converts the image represented by the PDL included in the print job into the intermediate data, and the raster image generation processing unit 51 that generates the raster image by executing the rasterization processing on the converted intermediate data.

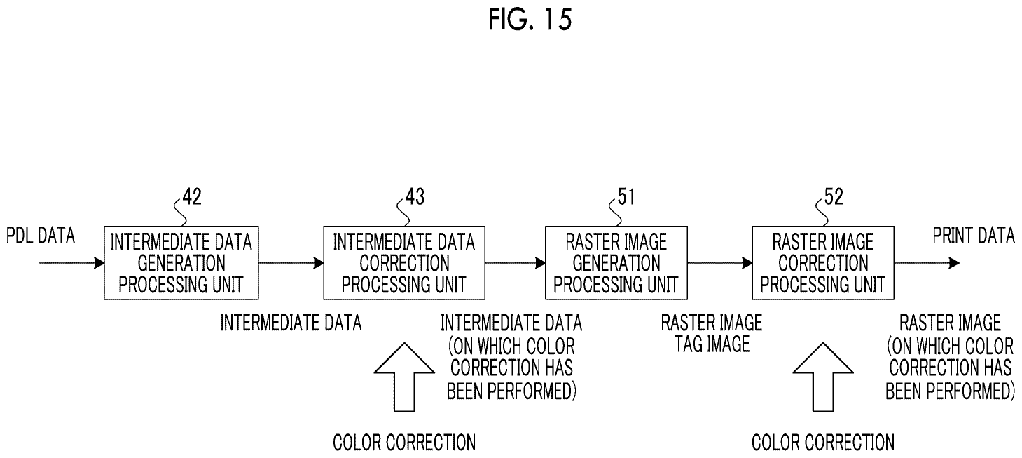

FIG. 15 shows a data flow between the processing units in the print server 10.

First, the print job, which is the PDL data input from the client terminal 20, is converted into the intermediate data by the intermediate data generation processing unit 42. Then, the color correction is performed on the intermediate data in the intermediate data correction processing unit 43. The color-corrected intermediate data is converted into the raster image and a TAG image representing an attribute of each pixel constituting the raster image by the raster image generation processing unit 51. Finally, the raster image correction processing unit 52 processes the raster image and the TAG image input from the raster image generation processing unit 51, and outputs the processed raster image and TAG image as the print data printable by the printer 30.

As shown in FIG. 15, in a case where the color correction is performed on the image to be printed, the color correction can be performed at the stage of the intermediate data in the intermediate data correction processing unit 43, or the color correction can be performed at the stage of the raster image in the raster image correction processing unit 52.

Whether or not the color correction is performed on the image to be printed and at which stage the color correction is performed in a case where the color correction is performed are designated in a case where the print instruction is issued from the client terminal 20 to the print server 10.

Here, as described above, in a case where the color correction is performed on the raster image in the raster image correction processing unit 52, the processing using the hardware can be executed, and thus fast processing can be realized. However, in a case where the intermediate data is converted into the raster image, the information such as the object type and the color space information in the attribute information on the PDL data is lost, and thus the defect may occur in the color-corrected image in a case where the color correction is performed on the raster image.

Meanwhile, in a case where the color correction is performed on the intermediate data in the intermediate data correction processing unit 43, it is possible to execute processing using accurate attribute information in the PDL data, so that it is possible to accurately reproduce the color. However, since it is necessary to execute color correction processing for each display object in the PDL data, a processing time may be lengthened.

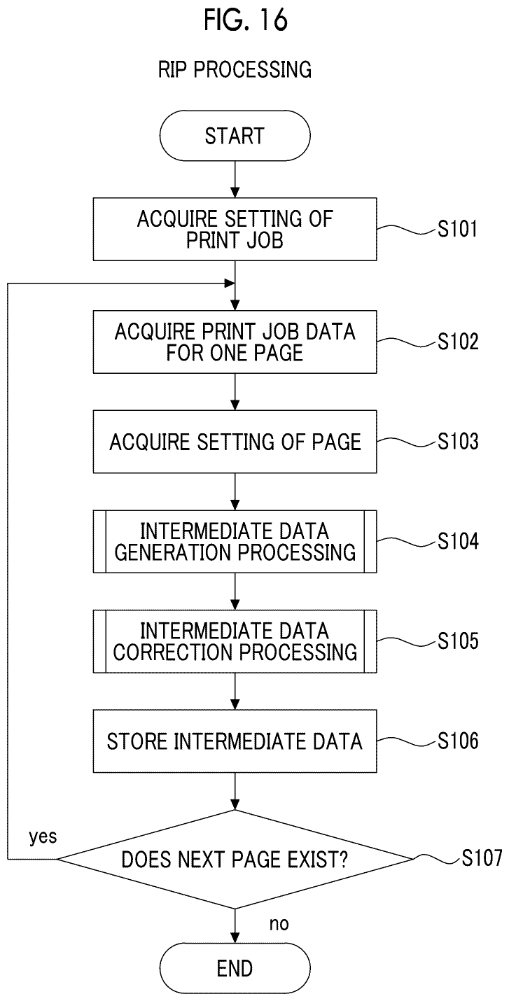

Next, a flow of RIP processing in the RIP processing unit 33 will be described with reference to a flowchart of FIG. 16.

First, in step S101, in a case where the RIP instruction for a certain print job is received from the job management unit 31, the RIP control unit 41 acquires setting information of the print job for which the RIP instruction is received.

Then, in step S102, the intermediate data generation processing unit 42 acquires the print job data for one page from the job data storage unit 32.

Then, the intermediate data generation processing unit 42 acquires the setting information of the page in step S103, and generates the intermediate data of the page based on the acquired setting information in step S104.

In a case where the color correction at the stage of the intermediate data is designated, in step S105, the intermediate data correction processing unit 43 performs the color correction on the intermediate data generated by the intermediate data generation processing unit 42.

Then, in step S106, the intermediate data generation processing unit 42 stores the color-corrected intermediate data in the intermediate data storage unit 35.

Finally, in step S107, the intermediate data generation processing unit 42 determines whether or not the print job data of the next page exists, and repeats the processing of steps S102 to S106 in a case where the data of the next page exists. In a case where it is determined in step S107 that the print job data of the next page does not exist, the intermediate data generation processing unit 42 terminates the processing.

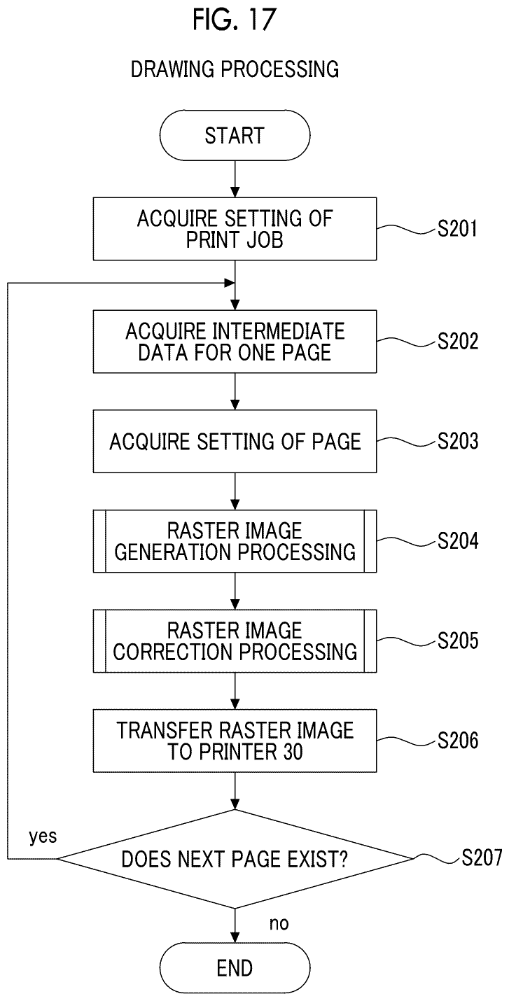

Next, a flow of drawing processing in the drawing processing unit 34 will be described with reference to a flowchart of FIG. 17.

First, in step S201, in a case where the rasterization instruction for a certain print job is received from the RIP control unit 41, the raster image generation processing unit 51 acquires the setting information of the print job for which the rasterization instruction is received.

Then, in step S202, the raster image generation processing unit 51 acquires the intermediate data for one page from the intermediate data storage unit 35.

The raster image generation processing unit 51 acquires the setting information of the page in step S203, and generates the raster image of the page based on the acquired setting information in step S204.

In a case where the color correction at the stage of the raster image is designated, in step S205, the raster image correction processing unit 52 performs the color correction on the raster image generated by the raster image generation processing unit 51.

Then, in step S206, the output control unit 53 transfers the color-corrected raster image to the printer 30.

Finally, in step S207, the raster image generation processing unit 51 determines whether or not the print job data of the next page exists, and repeats the processing of steps S202 to S206 in a case where the data of the next page exists. In a case where it is determined in step S207 that the print job data of the next page does not exist, the raster image generation processing unit 51 terminates the processing.

By executing the processing as described above, the print server 10 performs control of converting the print job data received from the client terminal 20 into the raster image and transferring the converted print job data to the printer 30, to execute the print processing based on the print job.

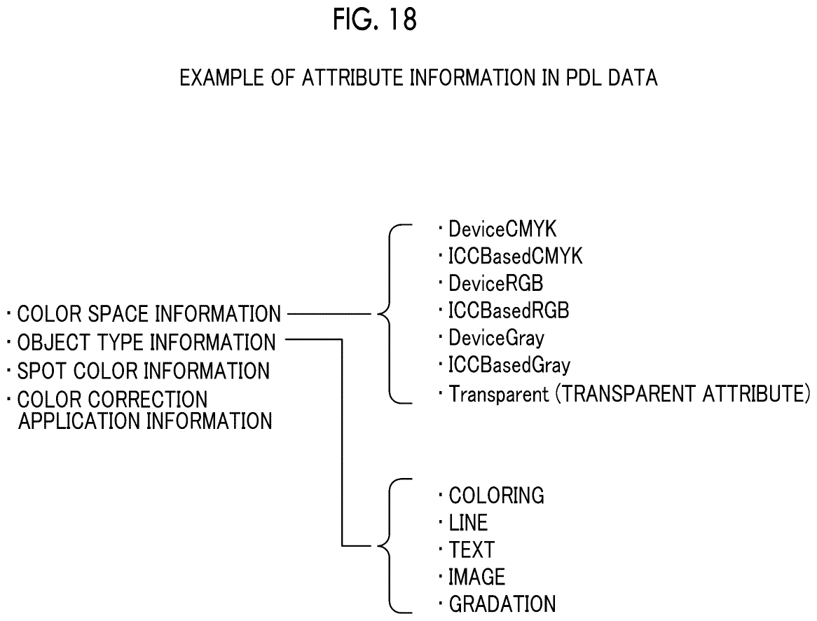

Here, the print job data (simply referred to as PDL data in some cases) described in the PDL format, which is received by the print server 10 from the client terminal 20, includes various types of attribute information. FIG. 18 shows an example of the attribute information included in the PDL data.

Referring to FIG. 18, the PDL data includes color space information, object type information, spot color information, color correction application information, and the like. It can be seen that the color space information includes information indicating a transparent attribute, which is “Transparent”, together with information indicating a representation format that defines each pixel value of the image. The object type information includes information indicating a type of the display object, such as coloring, a line, a text, an image, and a gradation.

In a case where the PDL data is converted into the intermediate data, the intermediate data generation processing unit 42 can determine whether or not there is a possibility of the occurrence of the defect in the color-corrected image in a case where the color correction is performed on the raster image, with reference to such attribute information.

In a case where a warning function is set to be valid based on the operation from the client terminal 20, the intermediate data generation processing unit 42 specifies the display object having the possibility of the occurrence of the defect in the image in a case where the color correction is performed on the raster image in the raster image correction processing unit 52, and holds the information indicating the specified display object in the intermediate data as the attribute information.

Specifically, in a case where the color correction is designated for the raster image in the print job and there is the possibility of the occurrence of the defect in the color-corrected image in a case where the color correction is performed on the raster image, the intermediate data generation processing unit 42 issues a warning to the user by holding that the defect will occur in the color-corrected image as the attribute information in the intermediate data.

For example, based on the attribute information held in the intermediate data, which indicates that there is the possibility of the occurrence of the image defect, the intermediate data correction processing unit 43 issues, in a case where there is the possibility of the occurrence of the defect in the color-corrected image in a case where the color correction is performed on the raster image, the warning to the user about the defect that will occur in the color-corrected image by executing processing on the display object having the possibility of the occurrence of the defect in the color-corrected image, the processing being different from processing on other display objects.

Specifically, the intermediate data correction processing unit 43 issues the warning to the user about the defect that will occur in the color-corrected image by converting the display object having the possibility of the occurrence of the defect in the color-corrected image into a monochromatic display object, for example, a display object of a warning color, such as red, or by deleting the display objects other than the display object having the possibility of the occurrence of the defect in the color-corrected image.
the intermediate data correction processing unit 43 may issue, in a case where there is the possibility of the occurrence of the defect in the color-corrected image in a case where the color correction is performed on the raster image, the warning to the user about the defect that will occur in the color-corrected image by executing processing on a pixel of a region having the possibility of the occurrence of the defect in the color-corrected image, the processing being different from processing on pixels of other regions.

For example, the intermediate data correction processing unit 43 issues the warning to the user about the defect that will occur in the color-corrected image by changing a density value for each color of the pixel of the region having the possibility of the occurrence of the defect in the color-corrected image via a preset change method, such as making the density value extremely bright or extremely dark.

The color correction for issuing such a warning to the user may be performed by the raster image correction processing unit 52 instead of being performed by the intermediate data correction processing unit 43.

In this case, the raster image generation processing unit 51 generates the raster image and the TAG image including the information for specifying the pixel at which the image defect occurs, based on the information indicating that there is the possibility of the occurrence of the image defect, which is held as the attribute information in the intermediate data. Then, the raster image correction processing unit 52 specifies the pixel having the possibility of the occurrence of the image defect based on the TAG image, and issues the warning to the user by making the specified pixel stand out by performing different color correction from the other pixels.

Here, the intermediate data generation processing unit 42 may receive selection of whether or not to issue the warning about the defect that will occur in the color-corrected image from the user, and issue the warning to the user about the defect that will occur in the color-corrected image only in a case where the user selects to issue the warning about the defect that will occur in the color-corrected image.

Next, a condition under which the intermediate data generation processing unit 42 determines that there is the possibility of the occurrence of the defect in the color-corrected image in a case where the color correction is performed on the raster image will be described.

For the display object to which the drop shadow effect as shown in FIG. 3 is applied and the gradation object of the spot color as shown in FIG. 10, the transparent effect is applied, and the information indicating the transparent attribute is included in the color space information.

Therefore, the intermediate data generation processing unit 42 determines that the defect will occur in the color-corrected image in a case where the color correction on the raster image is designated in the print job and a display object to which a transparent effect is applied exists among display objects in an image included in the print job, issues the warning to the user about the defect that will occur in the color-corrected image.

In a case where there is the possibility of the occurrence of the defect in the color-corrected image in a case where the color correction is performed on the raster image, the intermediate data generation processing unit 42 may suggest a countermeasure to prevent the image defect from occurring in addition to only issuing the warning to the user.

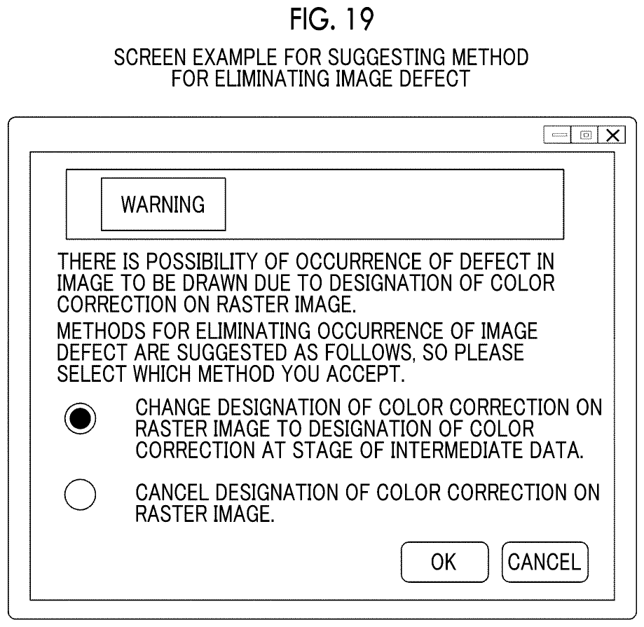

For example, FIG. 19 shows a display screen example in a case of making such a suggestion on a display screen of raster image viewer software for displaying the raster image in a preview manner on the client terminal 20.

For example, in a case of issuing the warning to the user about the defect that will occur in the color-corrected image, the intermediate data generation processing unit 42 displays a suggestion to the user to change the designation of the color correction on the raster image to the designation of the color correction at the stage of the intermediate data, on the client terminal 20 via the RIP control unit 41 and the job management unit 31. In the display screen example of FIG. 19, it can be seen that an option of “change the designation of the color correction on the raster image to the designation of the color correction at the stage of the intermediate data” is shown. In a case where the user selects this option and accepts such a suggestion, the intermediate data generation processing unit 42 re-executes the processing of converting the image data included in the print job into the raster image by converting the image data included in the print job into the intermediate data again such that the color correction is performed in the intermediate data correction processing unit 43.

Alternatively, in a case of issuing the warning to the user about the defect that will occur in the color-corrected image, the intermediate data generation processing unit 42 displays a suggestion to the user to cancel the designation of the color correction on the raster image, on the client terminal 20 via the RIP control unit 41 and the job management unit 31. In the display screen example of FIG. 19, it can be seen that an option of “cancel the designation of the color correction on the raster image” is shown. In a case where the user selects this option and accepts such a suggestion, the color correction on the generated raster image is stopped.

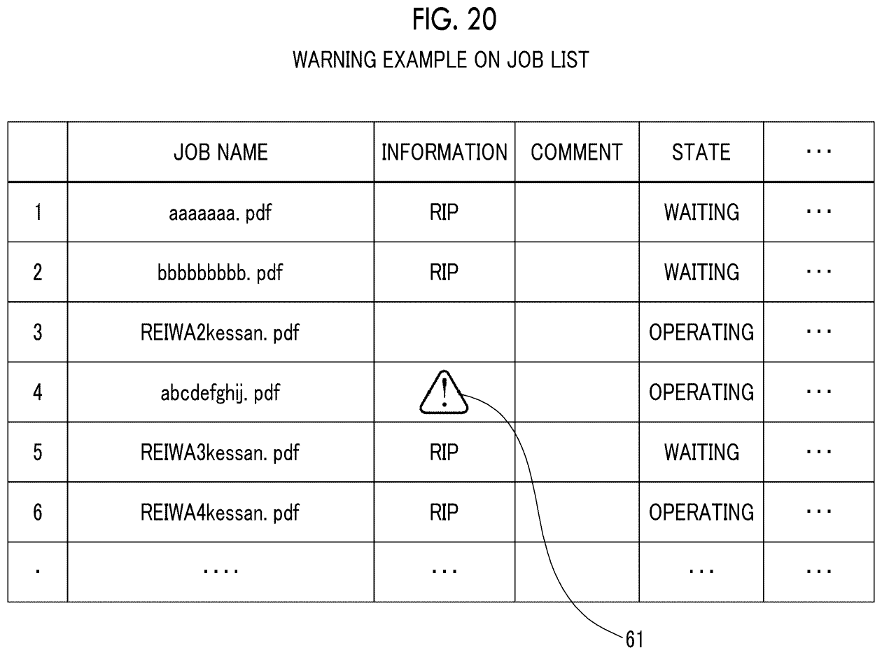

Next, FIG. 20 shows a display screen example in a case where the intermediate data generation processing unit 42 issues the warning to the user about the defect that will occur in the color-corrected image on the client terminal 20 via the RIP control unit 41 and the job management unit 31.

With reference to FIG. 20, in a job list showing the states of a plurality of print jobs, a warning mark 61 is displayed in an information field for the print job having a job name of “abcdefghij.pdf”. The warning mark 61 is a display icon for issuing the warning to the user that there is the possibility of the occurrence of the defect in the color-corrected image in a case where the color correction is performed with the current setting.

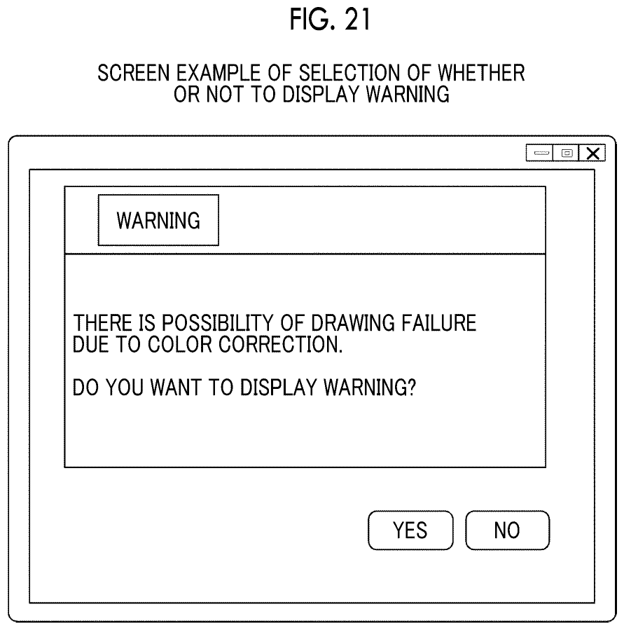

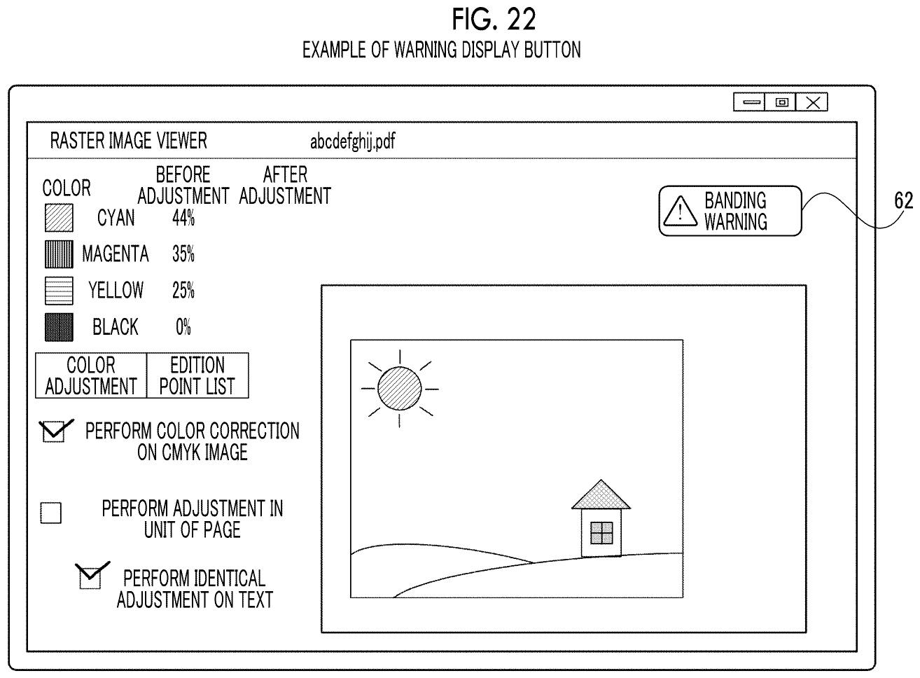

Next, FIGS. 21 and 22 show examples of a screen in a case where the intermediate data generation processing unit 42 receives the selection of whether or not to issue the warning about the defect that will occur in the color-corrected image from the user. Both FIG. 21 and FIG. 22 are examples of a display screen of the raster image viewer software described above.

In FIG. 21, it can be seen that, on the client terminal 20, a message “There is a possibility of drawing failure due to color correction.” is displayed on a preview display screen of the raster image, the warning is issued to the user, and a query “Do you want to display a warning?” is issued. In a case where the user selects “Yes” on the display screen, warning processing such as the substitution of the display object having the possibility of the occurrence of the image defect for the warning color is executed. In a case where the user selects “No” on the display screen, normal image processing is executed and the print processing is executed without performing special processing.

That is, the warning is issued to the user about the defect that will occur in the color-corrected image only in a case where the user selects to issue the warning about the defect that will occur in the color-corrected image.

In addition, in the display screen example shown in FIG. 22, an operation button 62 for switching whether or not to issue the warning on the display screen of the raster image viewer software is provided, and the selection of whether or not to issue the warning is received by the user's operation.

Next, specific processing in a case where the warning is issued to the user about the defect that will occur in the color-corrected image in a case where the color correction is performed at the stage of the raster image will be described in detail.

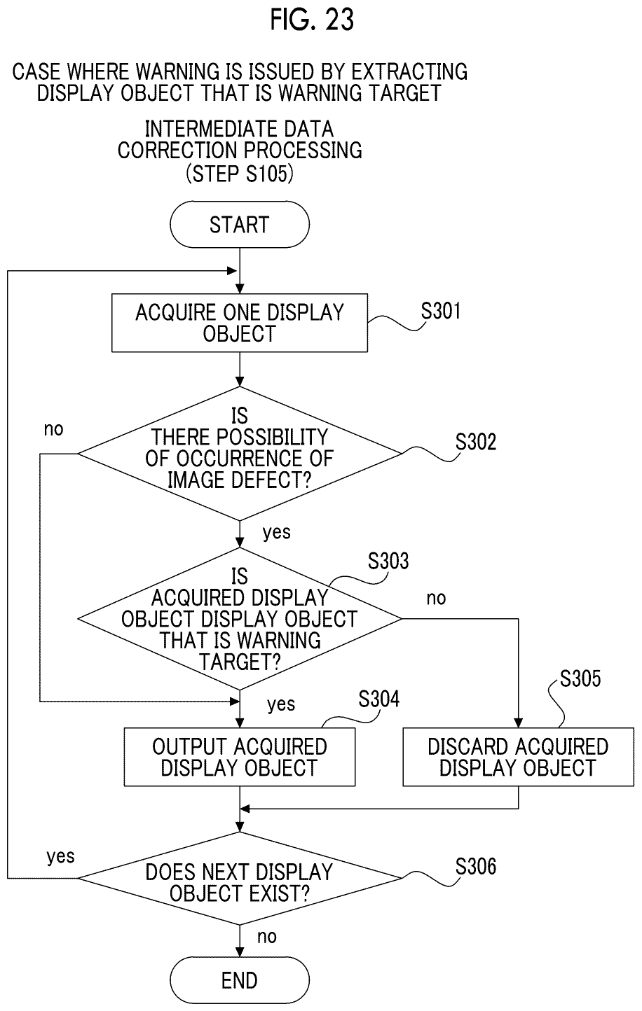

First, processing in a case where the warning is issued by extracting only the display object that is a warning target is shown in a flowchart of FIG. 23.

The flowchart of FIG. 23 shows an outline of the intermediate data correction processing shown in step S105 of the flowchart shown in FIG. 16. In the flowchart of FIG. 23, the processing of converting the PDL data into the intermediate data is omitted, and only the processing on the display object that is the warning target is shown.

First, in step S301, the intermediate data correction processing unit 43 acquires one display object. Then, in step S302, the intermediate data correction processing unit 43 determines whether or not there is the possibility of the occurrence of the image defect based on the attribute information included in the intermediate data.

In a case where it is determined in step S302 that there is no possibility of the occurrence of the image defect, in step S304, the intermediate data correction processing unit 43 performs the color correction or the like required for the acquired display object and outputs the display object.

Then, in a case where it is determined in step S302 that there is the possibility of the occurrence of the image defect, in step S303, the intermediate data correction processing unit 43 determines whether or not the acquired display object is the display object that is the warning target.

In a case where it is determined in step S303 that the acquired display object is the display object that is the warning target, in step S304, the intermediate data correction processing unit 43 performs the color correction or the like required for the acquired display object and outputs the display object.

In a case where it is determined in step S303 that the acquired display object is not the display object that is the warning target, the intermediate data correction processing unit 43 discards the acquired display object in step S305.

In step S306, the intermediate data correction processing unit 43 determines whether or not a next display object exists, and terminates the processing in a case where it is determined that no next display object exists.

In addition, the intermediate data correction processing unit 43 repeats the processing of steps S301 to S305 in a case where it is determined in step S306 that the next display object exists.

By executing such processing, in a case where there is the possibility of the occurrence of the image defect, only the display object that is the warning target is output, and the other display objects are discarded.

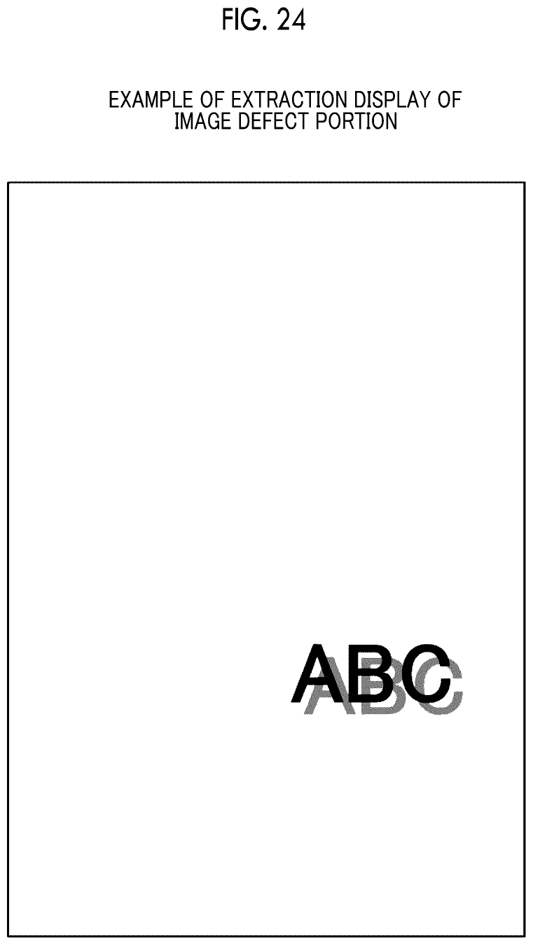

FIG. 24 shows an output example in a case where extraction display of such an image defect portion is performed. With reference to FIG. 24, a state is shown in which only a display object of a text string “ABC” having the possibility of the occurrence of the image defect in a case where the color correction is performed at the stage of the raster image is output, and the other display objects are deleted. In a case where the image is output in this way, the user can recognize that there is the possibility of the occurrence of the image defect in a case where the printing is executed with the current setting, and the cause is the display object of the text string “ABC”.

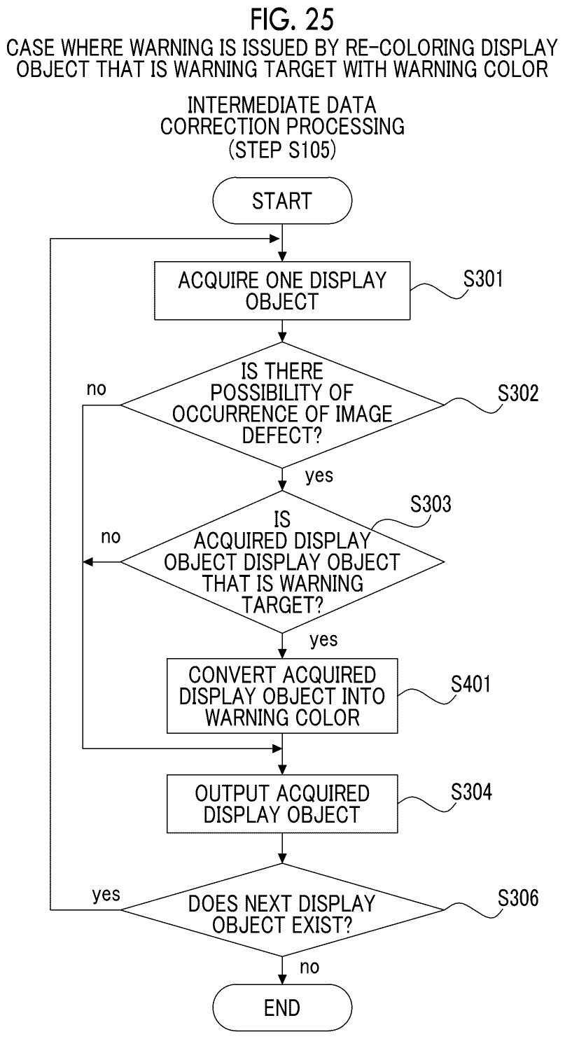

Next, processing in a case where the warning is issued by re-coloring the display object of the warning target with the warning color is shown in a flowchart of FIG. 25.

The flowchart of FIG. 25 also shows an outline of the intermediate data correction processing shown in step S105 of the flowchart shown in FIG. 16. In the flowchart of FIG. 25 as well, the processing of converting the PDL data into the intermediate data is omitted, and only the processing on the display object that is the warning target is shown.

In the flowchart of FIG. 25, only parts different from the flowchart of FIG. 23 will be described.

In FIG. 25, the intermediate data correction processing unit 43 determines that there is the possibility of the occurrence of the image defect in step S302, and in a case where it is determined in step S303 that the acquired display object is the display object that is the warning target, the intermediate data correction processing unit 43 performs the re-coloring by converting the acquired display object into a preset warning color in step S401.

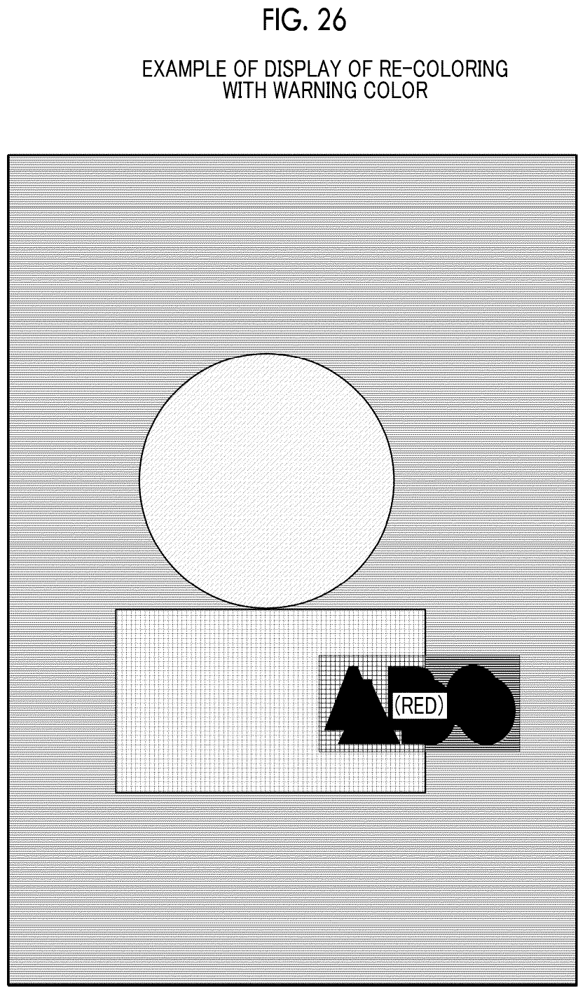

FIG. 26 shows an output example in a case where the color of the display object of such an image defect portion is re-colored with the warning color. With reference to FIG. 26, a state is shown in which the display object of the text string “ABC” having the possibility of the occurrence of the image defect in a case where the color correction is performed at the stage of the raster image is output in a state where the display object is colored with red. In a case where the image is output in this way, the user can recognize that there is the possibility of the occurrence of the image defect in a case where the printing is executed with the current setting, and the cause is the display object of the text string “ABC”.

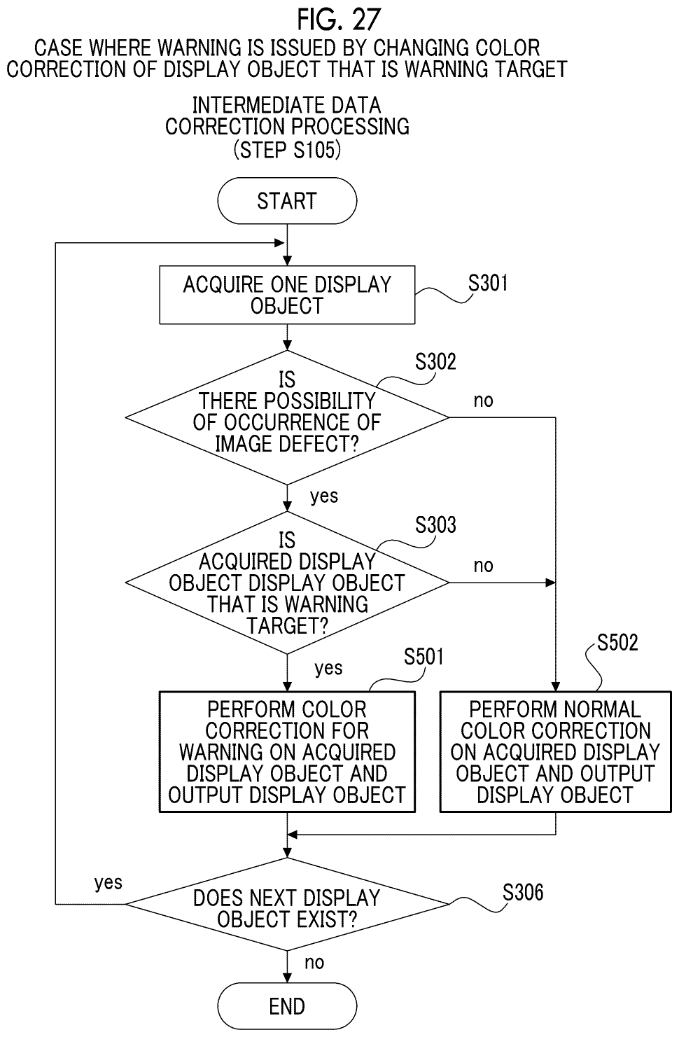

Next, processing in a case where the warning is issued by changing the color correction of the display object that is the warning target is shown in a flowchart of FIG. 27.

The flowchart of FIG. 27 also shows an outline of the intermediate data correction processing shown in step S105 of the flowchart shown in FIG. 16. In the flowchart of FIG. 27 as well, the processing of converting the PDL data into the intermediate data is omitted, and only the processing on the display object that is the warning target is shown.

In the flowchart of FIG. 27, only parts different from the flowcharts described in FIGS. 23 and 25 will be described.

In FIG. 27, the intermediate data correction processing unit 43 determines that there is the possibility of the occurrence of the image defect in step S302, and in a case where it is determined in step S303 that the acquired display object is the display object that is the warning target, the intermediate data correction processing unit 43 performs preset color correction for a warning on the acquired display object and outputs the display object in step S501. For example, the intermediate data correction processing unit 43 performs special color correction for a warning, such as halving a density value of the display object that is the warning target. In a case where it is determined in step S302 that there is no possibility of the occurrence of the image defect determines in step S303 that the acquired display object is not the display object that is the warning target, the intermediate data correction processing unit 43 performs normal color correction on the acquired display object and outputs the display object in step S502.

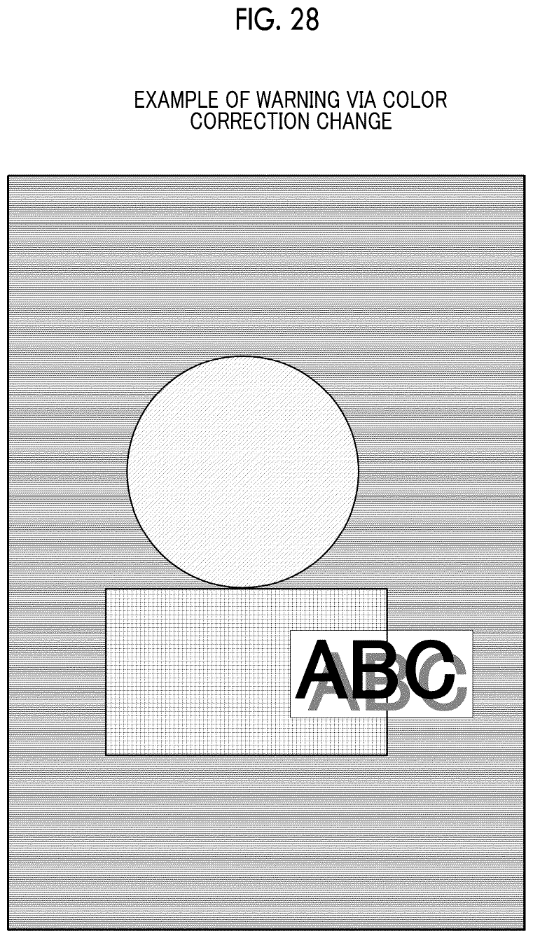

FIG. 28 shows an output example in a case where the color correction for a warning is performed on the display object of such an image defect portion. With reference to FIG. 28, a state is shown in which the display object of the text string “ABC” having the possibility of the occurrence of the image defect in a case where the color correction is performed at the stage of the raster image is output in a state where the color correction is performed such that the display object is made to stand out by extremely changing the brightness. In a case where the image is output in this way, the user can recognize that there is the possibility of the occurrence of the image defect in a case where the printing is executed with the current setting, and the cause is the display object of the text string “ABC”.

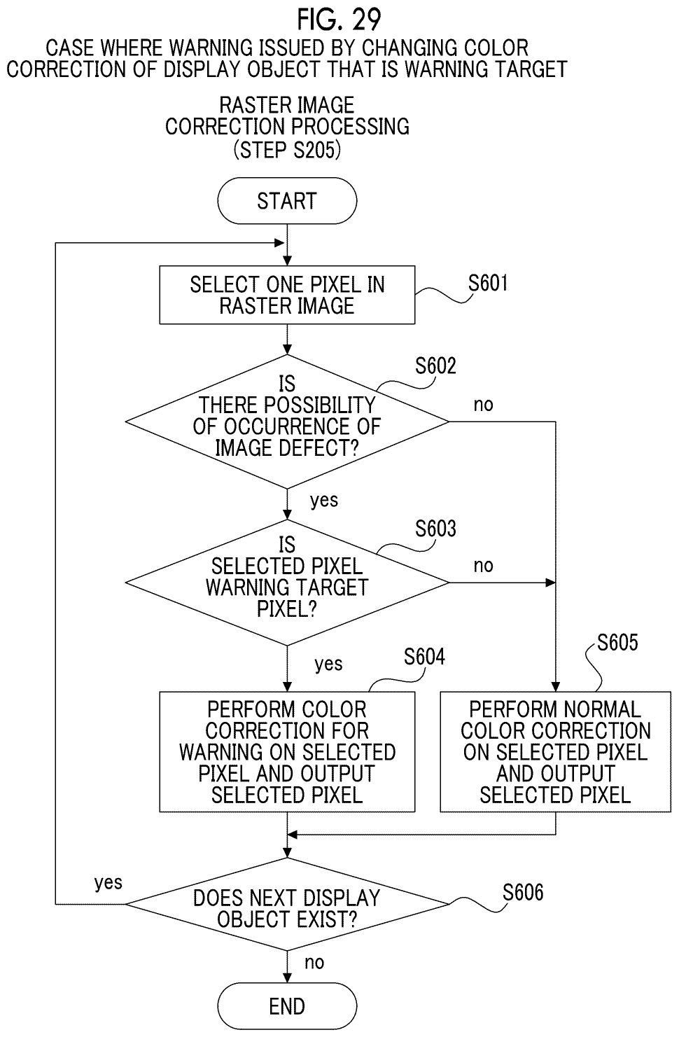

The flowcharts of FIGS. 23, 25, and 27 described above are all the cases in which the processing for a warning is executed in the intermediate data correction processing unit 43. On the other hand, the flowchart shown in FIG. 29 shows processing in a case where the warning is issued by changing the color correction of the display object that is the warning target in the raster image correction processing unit 52.

First, in step S601, the raster image correction processing unit 52 selects one pixel in the raster image. Then, in step S602, the raster image correction processing unit 52 determines whether or not there is the possibility of the occurrence of the image defect with reference to the TAG image.

In a case where it is determined in step S602 that there is no possibility of the occurrence of the image defect, the raster image correction processing unit 52 performs normal color correction on the selected pixel and outputs the pixel in step S605.

Then, in a case where it is determined in step S602 that there is the possibility of the occurrence of the image defect, the raster image correction processing unit 52 determines in step S603 whether or not the pixel selected with reference to the TAG image is a pixel that is the warning target.

In a case where it is determined in step S603 that the pixel selected is the pixel that is the warning target, the raster image correction processing unit 52 performs the color correction for a warning on the selected pixel and outputs the selected pixel in step S604.

In=a case where it is determined in step S603 that the selected pixel is not the pixel that is the warning target, the raster image correction processing unit 52 performs the normal color correction on the selected pixel and outputs the selected pixel in step S605.

In step S606, the raster image correction processing unit 52 determines whether or not a next pixel to be processed exists, and terminates the processing in a case where it is determined that no next pixel exists.

In a case where the raster image correction processing unit 52 determines in step S606 that the next pixel exists, the processing of steps S601 to S605 is repeated.

By executing such processing, in a case where there is the possibility of the occurrence of the image defect, the raster image correction processing unit 52 executes the color correction for the warning display on the pixel that is the warning target at the stage of the raster image.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present exemplary embodiment includes both a system configured by a plurality of devices and a system configured with a single device.

### Supplementary Note

Hereinafter, supplementary notes of the aspects of the present disclosure will be described.

(((1)))

An image processing system comprising:
a processor configured to:
   in a case where color correction on a raster image is designated in a print instruction and there is a possibility of an occurrence of a defect in a color-corrected image in a case where the color correction is performed on the raster image, issue a warning to a user about the defect that will occur in the color-corrected image.
      (((2)))

The image processing system according to (((1))), wherein the processor is configured to:
in a case where the color correction on the raster image is designated in the print instruction and a display object to which a transparent effect is applied exists among display objects in an image included in the print instruction, issue the warning to the user about the defect that will occur in the color-corrected image.
   (((3)))

The image processing system according to (((2))), further comprising:
an image conversion unit that converts an image represented by a page description language included in the print instruction into intermediate data and executes rasterization processing on the converted intermediate data to generate the raster image,
wherein the processor is configured to:
   suggest the user to change the designation of the color correction on the raster image to designation of the color correction at a stage of the intermediate data in a case of issuing the warning to the user about the defect that will occur in the color-corrected image, and re-execute processing of converting image data included in the print instruction into the raster image in a case where the user accepts the suggestion.
      (((4)))

The image processing system according to (((2))), wherein the processor is configured to:
suggest the user to cancel the designation of the color correction on the raster image in a case of issuing the warning the user about the defect that will occur in the color-corrected image, and stop the color correction on a generated raster image in a case where the user accepts the suggestion.
   (((5)))

The image processing system according to (((1))) or (((2))), wherein the processor is configured to:
in a case where there is the possibility of the occurrence of the defect in the color-corrected image in a case where the color correction is performed on the raster image, issue the warning to the user about the defect that will occur in the color-corrected image by executing processing on a display object having the possibility of the occurrence of the defect in the color-corrected image, the processing being different from processing on other display objects.
   (((6)))

The image processing system according to (((5))), wherein the processor is configured to:
issue the warning to the user about the defect that will occur in the color-corrected image by converting the display object having the possibility of the occurrence of the defect in the color-corrected image into a monochromatic display object or by deleting the display objects other than the display object having the possibility of the occurrence of the defect in the color-corrected image.
   (((7)))

The image processing system according to (((1))) or (((2))), wherein the processor is configured to:
in a case where there is the possibility of the occurrence of the defect in the color-corrected image in a case where the color correction is performed on the raster image, issue the warning to the user about the defect that will occur in the color-corrected image by executing processing on a pixel of a region having the possibility of the occurrence of the defect in the color-corrected image, the processing being different from processing on pixels of other regions.
   (((8)))

The image processing system according to (((7))), wherein the processor is configured to:
issue the warning to the user about the defect that will occur in the color-corrected image by changing a density value for each color of the pixel of the region having the possibility of the occurrence of the defect in the color-corrected image via a preset change method.
   (((9)))

The image processing system according to any one of (((1))) to (((8))), wherein the processor is configured to:
receive selection of whether or not to issue the warning about the defect that will occur in the color-corrected image from the user, and issue the warning to the user about the defect that will occur in the color-corrected image only in a case where the user selects to issue the warning about the defect that will occur in the color-corrected image.
   (((10)))

A program causing a computer to execute a process comprising:
receiving a print instruction; and
issuing, in a case where color correction on a raster image is designated in the received print instruction and there is a possibility of an occurrence of a defect in a color-corrected image in a case where the color correction is performed on the raster image, a warning to a user about the defect that will occur in the color-corrected image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
a processor configured to:
in a case where color correction on a raster image is designated in a print instruction and there is a possibility of an occurrence of a defect in a color-corrected image in a case where the color correction is performed on the raster image, issue a warning to a user about the defect that will occur in the color-corrected image.

2. The image processing system according to claim 1, wherein the processor is configured to:
in a case where the color correction on the raster image is designated in the print instruction and a display object to which a transparent effect is applied exists among display objects in an image included in the print instruction, issue the warning to the user about the defect that will occur in the color-corrected image.

3. The image processing system according to claim 2, further comprising:
an image conversion unit that converts an image represented by a page description language included in the print instruction into intermediate data and executes rasterization processing on the converted intermediate data to generate the raster image,
wherein the processor is configured to:
suggest the user to change the designation of the color correction on the raster image to designation of the color correction at a stage of the intermediate data in a case of issuing the warning to the user about the defect that will occur in the color-corrected image, and re-execute processing of converting image data included in the print instruction into the raster image in a case where the user accepts the suggestion.

4. The image processing system according to claim 2, wherein the processor is configured to:
suggest the user to cancel the designation of the color correction on the raster image in a case of issuing the warning the user about the defect that will occur in the color-corrected image, and stop the color correction on a generated raster image in a case where the user accepts the suggestion.

5. The image processing system according to claim 1, wherein the processor is configured to:
in a case where there is the possibility of the occurrence of the defect in the color-corrected image in a case where the color correction is performed on the raster image, issue the warning to the user about the defect that will occur in the color-corrected image by executing processing on a display object having the possibility of the occurrence of the defect in the color-corrected image, the processing being different from processing on other display objects.

6. The image processing system according to claim 5, wherein the processor is configured to:
issue the warning to the user about the defect that will occur in the color-corrected image by converting the display object having the possibility of the occurrence of the defect in the color-corrected image into a monochromatic display object or by deleting the display objects other than the display object having the possibility of the occurrence of the defect in the color-corrected image.

7. The image processing system according to claim 1, wherein the processor is configured to:
in a case where there is the possibility of the occurrence of the defect in the color-corrected image in a case where the color correction is performed on the raster image, issue the warning to the user about the defect that will occur in the color-corrected image by executing processing on a pixel of a region having the possibility of the occurrence of the defect in the color-corrected image, the processing being different from processing on pixels of other regions.

8. The image processing system according to claim 7, wherein the processor is configured to:
issue the warning to the user about the defect that will occur in the color-corrected image by changing a density value for each color of the pixel of the region having the possibility of the occurrence of the defect in the color-corrected image via a preset change method.

9. The image processing system according to claim 1, wherein the processor is configured to:
receive selection of whether or not to issue the warning about the defect that will occur in the color-corrected image from the user, and issue the warning to the user about the defect that will occur in the color-corrected image only in a case where the user selects to issue the warning about the defect that will occur in the color-corrected image.

10. A non-transitory computer-readable program recording medium causing a computer to execute a process comprising:
receiving a print instruction; and
issuing, in a case where color correction on a raster image is designated in the received print instruction and there is a possibility of an occurrence of a defect in a color-corrected image in a case where the color correction is performed on the raster image, a warning to a user about the defect that will occur in the color-corrected image.

11. An image processing method comprising:
receiving a print instruction; and
issuing, in a case where color correction on a raster image is designated in the received print instruction and there is a possibility of an occurrence of a defect in a color-corrected image in a case where the color correction is performed on the raster image, a warning to a user about the defect that will occur in the color-corrected image.
